(19) United States
(12) Patent Application Publication
(10) Pub. No.: US 2022/0019131 A1
(43) Pub. Date: Jan. 20, 2022

(54) CONNECTING DEVICE FOR CONNECTING A LENS HOUSING TO AN IMAGE SENSOR SUBSTRATE FOR A CAMERA

(71) Applicant: Robert Bosch GmbH, Stuttgart (DE)

(72) Inventors: Andreas Moehrle, Stuttgart (DE); Johannes Eschler, Weil Der Stadt (DE); Moritz Winkler, Waldbronn (DE); Nikolai Bauer, Moeglingen (DE)

(21) Appl. No.: 17/305,592

(22) Filed: Jul. 9, 2021

(30) Foreign Application Priority Data
Jul. 15, 2020 (DE) 10 2020 208 786.5

(51) Int. Cl. G03B 17/12; G02B 7/02

(52) U.S. Cl. CPC G03B 17/12; G02B 7/021

(57) ABSTRACT

A connecting device for connecting a lens housing for accommodating at least one lens including an image sensor substrate for accommodating an image sensor for a camera. The connecting device includes a first lens holder element and a second lens holder element. The first lens holder element is formed as coupled or coupleable axially with the lens housing. The second lens holder element is formed as coupled or coupleable to the image sensor substrate, the first lens holder element and the second lens holder element being formed as coupled or coupleable axially with one another.

### CROSS REFERENCE

The present application claims the benefit under 35 U.S.C. § 119 of German Patent Application No. DE 102020208786.5 filed on Jul. 15, 2020, which is expressly incorporated herein by reference in its entirety.

### FIELD

The present invention is directed to a device and a method for connecting a lens housing to an image sensor substrate for a camera. The present invention is also directed to a computer program.

### BACKGROUND INFORMATION

In a camera, an image sensor and a lens or a lens stack are installed on an optical axis in relation to one another.

### SUMMARY

The present invention provides a connecting device for connecting a lens housing to an image sensor substrate for a camera, a housing device, a camera, and a method for installing a connecting device. Advantageous refinements and improvements of the device disclosed herein are possible by way of the measures set forth herein.

Advantages achievable by example embodiments of the present invention include that a particularly stable and durable connecting device for connecting a lens housing to an image sensor substrate for a camera is created.

In accordance with an example embodiment of the present invention, a connecting device for connecting a lens housing for accommodating at least one lens to an image sensor substrate for accommodating an image sensor for a camera is provided. The connecting device includes a first lens holder element and a second lens holder element. The first lens holder element is formed so it is coupled or may be coupled axially with the lens housing. The second lens holder element is formed so that it is coupled or may be coupled with the image sensor substrate, the first lens holder element and the second lens holder element being formed as coupled or coupleable axially with one another.

“Axially” is to be understood in this context as being with respect to an orientation of the optical axis on which the lens and the image sensors are situated or provided. For example, a coupling of the first lens holder element with the lens housing may be implemented in parallel to the optical axis. Accordingly, a further coupling of the first lens holder element with the second lens holder element may be implemented in parallel to the optical axis. Such axial couplings advantageously enable mutual compensation of forces acting upon the coupled elements. The image sensor substrate may be a circuit board.

The first lens holder element may be formed to be S-shaped or Z-shaped in cross section, for example. In this case, the first lens holder element may include in cross section a middle web including two legs extending away perpendicularly at opposite ends on opposite sides of the middle web. The legs and/or the middle web may be formed to be linear. Overall, the first lens holder element may be formed to be cup-shaped, for example having a through opening in the bottom of the cup for the insertion of the lens housing, and a flange situated on the side of the cup opposite to the bottom. The bottom and the flange may be the above-described legs in cross section in this case. Such a formation which is S-shaped or Z-shaped in cross section of the first lens holder element enables stable coupling both with the lens housing and with the second lens holder element, for example each on the legs.

According to one specific example embodiment of the present invention, the first lens holder element may be coupled firmly bonded with the lens housing and/or firmly bonded with the second lens holder element. This creates a fast and particularly durable fastening option. The first lens holder element may, for example, be adhesively bonded, soldered, or welded to the lens housing and/or the second lens holder element.

Furthermore, it is advantageous if the second lens holder element is coupled or may be coupled in a friction-locked and/or formfitting manner with the image sensor substrate, in particular the second lens holder element being able to be screwed and/or riveted onto the image sensor substrate. A direct connection of the second lens holder element to the image sensor substrate implemented in this way advantageously enables thermal conduction from the image sensor via the image sensor substrate to the second lens holder element. Thus, for example, occurring heat may be dissipated from the image sensor via the second lens holder element.

According to one specific example embodiment of the present invention, the second lens holder element may include a projection, which is formed so it is coupled or may be coupled with the first lens holder element. The projection may extend perpendicularly to the optical axis, for example, may extend toward the optical axis. Such a projection may offer a coupling surface for the first lens holder element. In this case, the first lens holder element may encompass or engage behind at least one section of the projection upon coupling.

In another possible specific example embodiment of the present invention, the second lens holder element may include a coupling surface for coupling with a camera housing and/or the second lens holder element may include a further coupling surface for coupling with the camera housing. The coupling surface and further coupling surface may extend perpendicularly to one another in the installed state of the connecting device. Furthermore, the coupling surface and/or further coupling surface may be formed to be planar. Upon contact with the camera housing, the coupling surface may be used for removing heat generated in the image sensor to the camera housing. Upon contact with the camera housing, the further coupling surface may be used for stability of the connecting device within the camera housing.

Furthermore, in accordance with an example embodiment of the present invention, a housing device is provided including a connecting device, which is formed in one of the above-described variants, and the lens housing for accommodating at least one lens. The lens housing may also be formed to accommodate a plurality of lenses, which may be able to be situated, for example, in the form of a stack in the lens housing. For this purpose, the lens housing may be formed in the form of a hollow cylinder, for example, to accommodate the lens stack in an interior of the lens housing. Such a housing device enables a stable accommodation of optical elements of a camera, a focus drift advantageously being compensated for thanks to the axial couplings of the connecting device in operation of the camera.

The lens housing may include an interior, which is formed to accommodate the lens, and may include an outer wall facing away from the interior, from which a collar extends away, which is formed so it is coupled or may be coupled axially with the first lens holder element. Such a collar may be used for stable coupling with the first lens holder element. The collar may be formed like a flange, for example, extending circumferentially around the outer wall of the hollow-cylindrical lens housing.

According to one specific embodiment of the present invention, the first lens holder element encompasses the collar and/or encompasses or engages behind a projection of the second lens holder element. This enables increased stability of the connecting device at the lens housing and/or the image sensor substrate by a form fit.

In accordance with an example embodiment of the present invention, a camera includes one of the above-described housing devices and at least the lens accommodated in the lens housing of the housing device and the image sensor substrate including the image sensor. Such a camera implements the above-explained advantages of the connecting device.

In accordance with an example embodiment of the present invention, a method for installing a connecting device for connecting a lens housing for accommodating at least one lens with an image sensor substrate for accommodating an image sensor for a camera includes a step of providing and a step of coupling. In the step of providing, a first lens holder element is provided, which is formed so it may be coupled axially with the lens housing, and a second lens holder element is provided, which is formed so it may be coupled with the image sensor substrate, the first lens holder element and the second lens holder element being formed so they may be axially coupled with one another. In the step of coupling, the first lens holder element is coupled with the lens housing and the second lens holder element and the second lens holder element is coupled with the image sensor substrate to install the connecting device.

This method may be implemented, for example, in software or hardware or in a mixed form of software and hardware, for example, in a control unit.

The present invention furthermore provides a device which is designed to carry out, control, or implement the steps of a variant of a method presented here in corresponding units. The object underlying the approach may also be achieved quickly and efficiently by this embodiment variant of the approach in the form of a device.

For this purpose, the device may include at least one processing unit for processing signals or data, at least one memory unit for storing signals or data, at least one interface to a sensor or an actuator for reading sensor signals from the sensor or for outputting data or control signals to the actuator, and/or at least one communication interface for reading or outputting data which are embedded in a communication protocol. The processing unit may be, for example, a signal processor, a microcontroller, or the like, the memory unit being able to be a flash memory, an EEPROM, or a magnetic memory unit. The communication interface may be designed to read or output data in a wireless and/or hard-wired manner, a communication interface which may read or output hard-wired data being able to read these data, for example, electrically or optically from a corresponding data transfer line or output these data into a corresponding data transfer line.

A device may be understood in the present case as an electrical device which processes sensor signals and outputs control and/or data signals as a function thereof. The device may include an interface which may be designed as hardware and/or software. With a hardware design, the interfaces may be, for example, part of a so-called system ASIC, which includes greatly varying functions of the device. However, it is also possible that the interfaces are separate integrated circuits or are made up at least partially of discrete components. In a software design, the interfaces may be software modules which are present, for example, on a microcontroller along with other software modules.

A computer program product or a computer program having program code which may be stored on a machine-readable carrier or memory medium such as a semiconductor memory, a hard drive memory, or an optical memory and is used to carry out, implement, and/or activate the steps of the method according to one of the above-described specific embodiments, in particular if the program product or program is executed on a computer or a device, is also advantageous.

Exemplary embodiments of the present invention are shown in the figures and explained in greater detail below.

### BRIEF DESCRIPTION OF THE DRAWINGS

FIG. 1 shows a schematic representation of a connecting device for connecting a lens housing for accommodating at least one lens to an image sensor substrate for accommodating an image sensor for a camera according to one exemplary embodiment of the present invention.

FIGS. 2 through 3 each show a schematic representation of a connecting device according to one exemplary embodiment of the present invention.

FIGS. 4 through 5 each show a schematic representation of a second lens holder element of a connecting device according to one exemplary embodiment of the present invention.

FIG. 6 shows a flowchart of a method for installing a connecting device for connecting a lens housing for accommodating at least one lens to an image sensor substrate for accommodating an image sensor for a camera according to one exemplary embodiment of the present invention.

### DETAILED DESCRIPTION OF EXAMPLE EMBODIMENTS

In the following description of advantageous exemplary embodiments of the present invention, identical or similar reference numerals are used for the elements shown in the various figures and that act similarly, a repeated description of these elements being omitted.

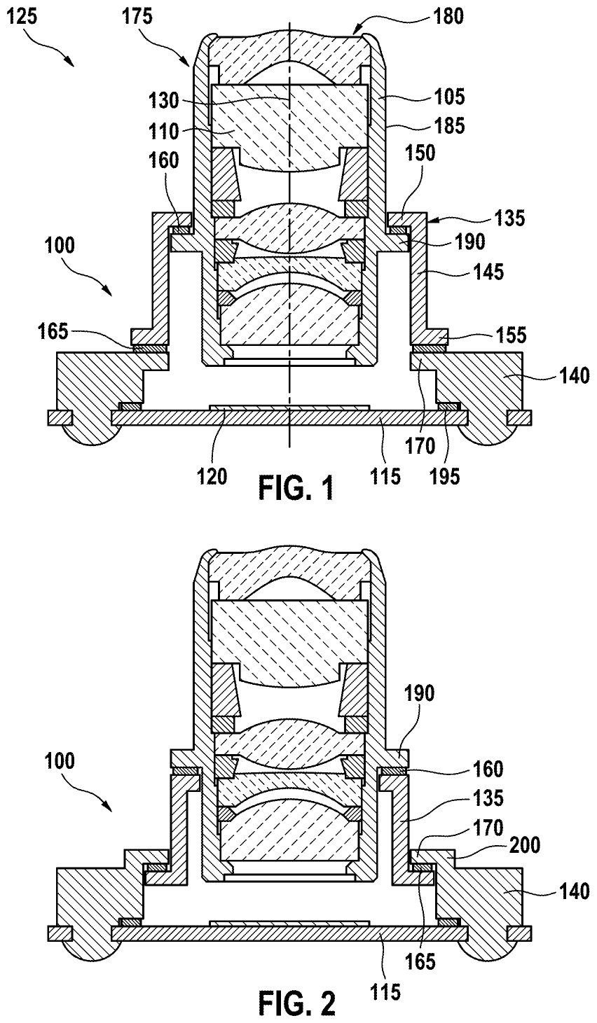

FIG. 1 shows a schematic representation of a connecting device 100 for connecting a lens housing 105 for accommodating at least one lens 110 to an image sensor substrate 115 for accommodating an image sensor 120 for a camera 125 according to one exemplary embodiment. A lateral cross section of connecting device 100 and all further described components is shown.

Solely by way of example, connecting device 100 according to this exemplary embodiment is installed at camera 125, which includes lens housing 105 having lens 110 accommodated in lens housing 105 and image sensor substrate 115 having image sensor 120. Lens 110 and image sensor 120 are situated on an optical axis 130. In an installed state shown here, connecting device 100 connects lens housing 105 to image sensor substrate 115. According to this exemplary embodiment, a plurality of lenses 110 in the form of a stack is accommodated in lens housing 105.

Connecting device 100 includes a first lens holder element 135 and a second lens holder element 140. First lens holder element 135 is axially coupled to lens housing 105. Second lens holder element 140 is coupled to image sensor substrate 115, first lens holder element 135 and second lens holder element 140 being axially coupled with one another. “Axial” is to be understood in this context as being with respect to an orientation of optical axis 130, on which lens 110 and image sensor 120 are situated or provided. According to this exemplary embodiment, a coupling of first lens holder element 135 with lens housing 105 is implemented in parallel to the optical axis. Correspondingly, according to this exemplary embodiment, a further coupling of first lens holder element 135 with second lens holder element 140 is implemented in parallel to optical axis 130. The coupling is situated according to this exemplary embodiment closer to optical axis 130 than the further coupling.

First lens holder element 135 and/or second lens holder element 140 are each integrally formed according to this exemplary embodiment. First lens holder element 135 according to this exemplary embodiment is formed to be S-shaped or Z-shaped in cross section. First lens holder element 135 according to this exemplary embodiment includes in cross section a middle web 145 including two legs 150, 155 extending away on opposite sides of middle web 145 perpendicularly at opposite ends. Legs 150, 155 and/or middle web 145 are formed extending linearly in cross section according to this exemplary embodiment. Overall, first lens holder element 135 according to this exemplary embodiment is formed cup-shaped, here having a through opening in the bottom of the cup for inserting lens housing 105 and a flange situated on a side of the cup opposite to the bottom. The bottom and the flange represent above-described legs 150, 155 here according to this exemplary embodiment.

According to this exemplary embodiment, first lens holder element 135 is coupled firmly bonded with lens housing 105 and/or firmly bonded with second lens holder element 140. First lens holder element 135 is glued according to this exemplary embodiment with the aid of an adhesion 160 with lens housing 105 and/or a further adhesion 165 with second lens holder element 140. According to an alternative exemplary embodiment, connecting device 100 includes at least one soldering or one welding instead of adhesion(s) 160, 165.

According to this exemplary embodiment, second lens holder element 140 is coupled in a friction-locked and/or form-fitting manner with image sensor substrate 115. In this case, according to this exemplary embodiment, second lens holder element 140 is riveted on image sensor substrate 115 or according to an alternative exemplary embodiment it is additionally or alternatively screwed.

According to this exemplary embodiment, second lens holder element 140 furthermore includes a projection 170, which is coupled with first lens holder element 135. Projection 170 extends according to this exemplary embodiment perpendicularly to optical axis 130, for example, toward optical axis 130 here.

Projection 170 has, according to this exemplary embodiment, a connecting surface for first lens holder element 135.

A housing device 175 also shown here includes connecting device 100 and lens housing 105. Lens housing 105 is formed to be hollow cylindrical in this exemplary embodiment to accommodate the at least one lens 110, here a lens stack made up of five stacked lenses 110 solely by way of example, in an interior 180 of lens housing 105. On an outer wall 185 facing away from interior 180, lens housing 105 includes a collar 190 extending away from outer wall 185, which is axially coupled with first lens holder element 135. Collar 190 is, according to this exemplary embodiment, formed like a flange, for example, extending circumferentially around outer wall 185 of hollow cylindrical lens housing 105. According to this exemplary embodiment, first lens holder element 135, first leg 150 here, encompasses collar 190.

Connecting device 100 provided here or entire camera 125 is usable in video-based driver assistance systems, industrial or security camera applications, and in consumer products.

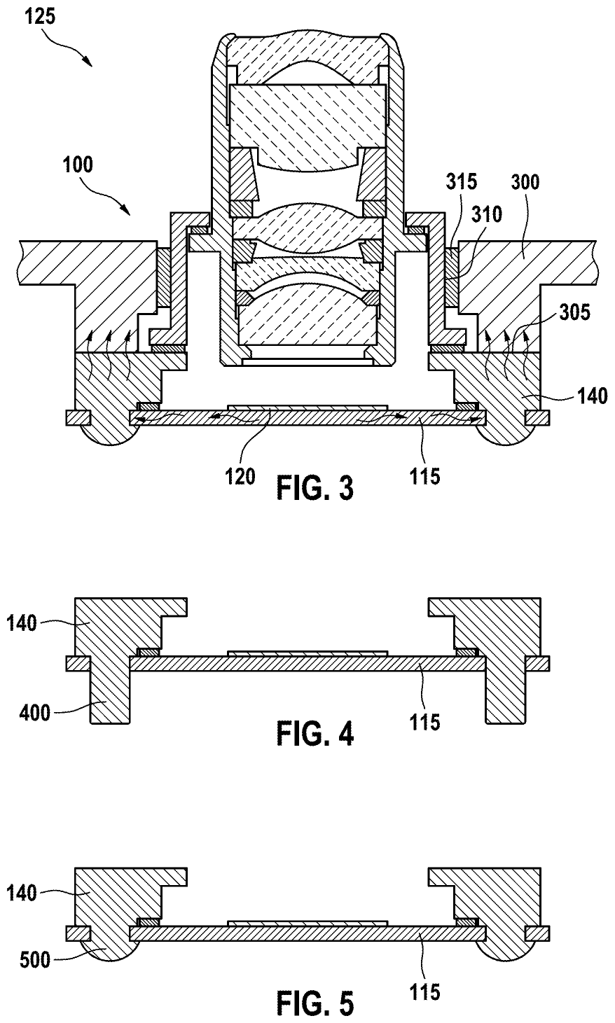

Connecting device 100 implements a two-part lens holder concept, in which first lens holder element 135 in the form of an upper lens holder is connected to collar 190 of lens housing 105 via an axial adhesion 160. Second lens holder element 140 in the form of a lower lens holder is connected to image sensor substrate 115 in the form of a circuit board not via an axial adhesion, but rather via a riveting or a screw joint. The two lens holder parts are connected to one another using a further axial adhesion 165. Second lens holder element 140 implements, according to this exemplary embodiment, a direct attachment on the circuit board. Cooling of image sensor 120 via the circuit board and second lens holder element 140 to a camera housing is thus improved; see also FIG. 3 in this regard. To shield a rear lens space, according to this exemplary embodiment, a double-sided glueable seal 195 is used, which is accommodated according to this exemplary embodiment between image sensor substrate 115 and second lens holder element 140.

Using connecting device 100 presented here, an imager module structure having a direct attachment of the circuit board to connecting device 100 in the form of a lens holder for the purpose of better cooling of image sensor 120 is advantageously enabled. The lens holder is made up of two parts, which are only connected, however, via two mutually compensating axial adhesions 160, 165 to the circuit board and to the objective lens. There is advantageously no radial adhesion.

In other words, connecting device 100 implements a two-part lens holder including direct attachment to the sensor substrate.

The structure presented here of camera 125, which may also be referred to as an imager module, includes the following features:
Lens housing 105, according to this exemplary embodiment, accommodates a lens packet on the inside, on the outer side, according to this exemplary embodiment, it has collar 190. According to this exemplary embodiment, lens housing 105 is connected with the aid of an axial adhesive bond on an upper side of collar 190, which faces away from lower second lens holder element 140, to upper first lens holder element 135. According to this exemplary embodiment, second lens holder element 140 is connected with the aid of further adhesion 165 in the form of an axial adhesive bond on an upper side of projection 170, which faces toward upper first lens holder element 135, to upper first lens holder element 135.
First lens holder element 135, according to this exemplary embodiment, includes at least one cylindrical and two horizontal planar sections. The upper planar section thereof, first leg 150 here, according to this exemplary embodiment, is axially connected to lens housing collar 190. The lower planar section, second leg 155 here, according to this exemplary embodiment, is also connected via an axial adhesion to lower second lens holder element 140.
Lower second lens holder element 140, according to this exemplary embodiment, includes at least one horizontal planar section, projection 170 here. This planar section is connected via an axial adhesion to upper first lens holder element 135. Furthermore, lower second lens holder element 140 is connected via a contact to the circuit board.
The circuit board is used as a carrier substrate for image sensor 120 and, according to this exemplary embodiment, is connected to lower second lens holder element 140 via a friction-locked or form-fitting connection, for example, screws or rivets.
Seal 195 is used according to this exemplary embodiment to shield the rear lens space from contamination. According to this exemplary embodiment, it is situated clamped between the circuit board and lower second lens holder element 140.

Lens housing 105, first lens holder element 135, and/or second lens holder element 140 are optionally formed from materials such as steel, nonferrous metal, plastic, or ceramic. These components may be made of an identical material or different materials. The focus drift is advantageously completely or partially compensated for by the selection of the component material, the adhesive for adhesions 160, 165, the adhesive thickness, and the design of the geometric dimensions.

FIG. 2 shows a schematic representation of a connecting device 100 according to one exemplary embodiment. This may be connecting device 100 described on the basis of FIG. 1, with the difference that first lens holder element 135 encompasses or engages behind at least one section of projection 170 and/or does not encompass collar 190 upon coupling. Projection 170, according to this exemplary embodiment, is furthermore situated elevated by a step 200 of second lens holder element 140.

An alternative embodiment of connecting device 100 also including two mutually compensating axial adhesive bonds is shown in FIG. 2. According to this exemplary embodiment, lens housing 105 is connected with the aid of adhesion 160, in the form of an axial adhesive bond on a lower side of collar 190 facing toward lower second lens holder element 140, to upper first lens holder element 135. According to this exemplary embodiment, second lens holder element 140 is connected with the aid of further adhesion 165, in the form of an axial adhesive bond on a lower side of projection 170 facing away from upper first lens holder element 135, to upper first lens holder element 135.

FIG. 3 shows a schematic representation of a connecting device 100 according to one exemplary embodiment. This may be connecting device 100 described on the basis of FIG. 1 or 2, with the difference that camera 125, according to this exemplary embodiment, is accommodated in a camera housing 300. Camera housing 300, according to this exemplary embodiment, is contacted with a coupling surface 305 of second lens holder element 140 and a further coupling surface 310 of first lens holder element 135. Camera housing 300 according to this exemplary embodiment is contacted directly with coupling surface 305 of second lens holder element 140 and indirectly, here via a seal element 315 or insulating element, with further coupling surface 310 of first lens holder element 135. Coupling surface 305 and further coupling surface 310, according to this exemplary embodiment, extend perpendicularly to one another and/or are formed to be planar in the installed state of connecting device 100.

Coupling surface 305 is used upon contact with camera housing 300 for removing heat generated in image sensor 120 to camera housing 300. The further coupling surface may be used upon contact with the camera housing for stability of the connecting device within the camera housing.

FIG. 4 shows a schematic representation of a second lens holder element 140 of a connecting device according to one exemplary embodiment. This may be one of second lens holder elements 140 described on the basis of the preceding figures, which is not yet riveted on image sensor substrate 115. A cylindrical, rectangular, or circular ring-shaped rivet section 400 of second lens holder element 140 is, according to this exemplary embodiment, situated guided through a through opening of image sensor substrate 115.

FIG. 5 shows a schematic representation of a second lens holder element 140 of a connecting device according to one exemplary embodiment. This may be second lens holder element 140 described in FIG. 4, with the difference that rivet section 400 has been riveted on image sensor substrate 115, in a semicircular shape here, for example. A direct attachment of the circuit board to the lens holder is thus implemented by a form-fitting connection, in the form of a rivet 500 here.

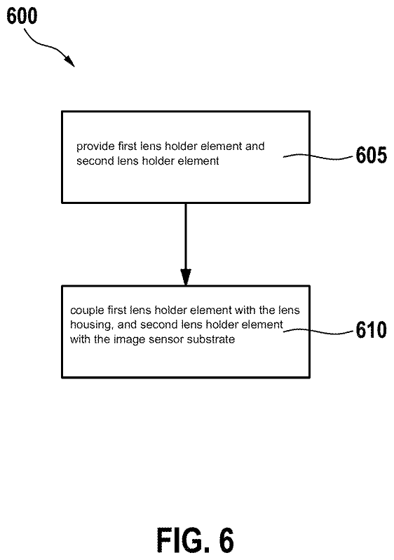

FIG. 6 shows a flowchart of a method 600 for installing a connecting device for connecting a lens housing for accommodating at least one lens to an image sensor substrate for accommodating an image sensor for a camera according to one exemplary embodiment. This may involve one of connecting devices 100 which was described in one of the preceding figures.

Method 600 includes a step 605 of providing and a step 610 of coupling. In step 605 of providing, a first lens holder element is provided, which is formed so it may be axially coupled with the lens housing, and a second lens holder element is provided, which is formed so it may be coupled with the image sensor substrate, the first lens holder element and the second lens holder element being formed so they may be axially coupled with one another. In step 610 of coupling, the first lens holder element is coupled with the lens housing and the second lens holder element is coupled with the image sensor substrate to install the connecting device. In step 610 of coupling, the first lens holder element is axially coupled with the lens housing and the first lens holder element is axially coupled with the second lens holder element.

If an exemplary embodiment includes an “and/or” linkage between a first feature and a second feature, this is to be read to mean that the exemplary embodiment according to one specific embodiment includes both the first feature and the second feature and according to another specific embodiment includes either only the first feature or only the second feature.

1-14. (canceled)

15. A connecting device for connecting a lens housing which accommodates at least one lens to an image sensor substrate which accommodates an image sensor for a camera, the connecting device comprising:
a first lens holder element formed as coupled or coupleable axially with the lens housing; and
a second lens holder element formed as coupled or coupleable to the image sensor substrate, the first lens holder element and the second lens holder element being formed as coupled or coupleable axially with one another.

16. The connecting device as recited in claim 15, wherein the first lens holder element S-shaped or Z-shaped in cross section.

17. The connecting device as recited in claim 15, wherein the first lens holder element is coupled firmly bonded with the lens housing and/or firmly bonded with the second lens holder element.

18. The connecting device as recited in claim 15, wherein the second lens holder element is coupled or may be coupled in a friction-locked and/or form-fitting manner with the image sensor substrate.

19. The connecting device as recited in claim 18, wherein the second lens holder element is screwed and/or riveted to the image sensor substrate.

20. The connecting device as recited in claim 15, wherein the second lens holder element includes a projection which is formed to be coupled or coupleable with the first lens holder element.

21. The connecting device as recited in claim 14, wherein: (i) the second lens holder element includes a coupling surface for coupling with a camera housing, and/or (ii) the first lens holder element includes a further coupling surface for coupling with the camera housing.

22. A housing device, comprising:
a connecting device for connecting a lens housing which accommodates at least one lens to an image sensor substrate which accommodates an image sensor for a camera, the connecting device including:
a first lens holder element formed as coupled or coupleable axially with the lens housing, and
a second lens holder element formed as coupled or coupleable to the image sensor substrate, the first lens holder element and the second lens holder element being formed as coupled or coupleable axially with one another; and
the lens housing which accommodates the at least one lens.

23. The housing device as recited in claim 22, wherein the lens housing includes an interior, which is formed to accommodate the lens, and includes an outer wall facing away from the interior from which a collar extends away, which is formed as coupled or coupleable axially with the first lens holder element.

24. The housing device as recited in claim 23, wherein the first lens holder element encompasses the collar and/or encompasses or engages behind a projection of the second lens holder element.

25. A camera, comprising:
a housing device which includes:
a connecting device for connecting a lens housing which accommodates at least one lens to an image sensor substrate which accommodates an image sensor for a camera, the connecting device including:
a first lens holder element formed as coupled or coupleable axially with the lens housing, and
a second lens holder element formed as coupled or coupleable to the image sensor substrate, the first lens holder element and the second lens holder element being formed as coupled or coupleable axially with one another; and
the lens housing which accommodates the at least one lens;
the at least one lens accommodated in the lens housing of the housing device; and
the image sensor substrate with the image sensor.

26. A method for installing a connecting device for connecting a lens housing which accommodates at least one lens with an image sensor substrate which accommodates an image sensor for a camera, the method comprising the following steps:
providing a first lens holder element which is formed to be axially coupleable with the lens housing, and a second lens holder element which is formed to be axially coupleable with the image sensor substrate, the first lens holder element and the second lens holder element being formed to be axially coupleable with one another; and
coupling the first lens holder element with the lens housing and the second lens holder element, and coupling the second lens holder element with the image sensor substrate to install the connecting device.

27. A device configured to install a connecting device for connecting a lens housing which accommodates at least one lens with an image sensor substrate which accommodates an image sensor for a camera, the device configured to:
provide a first lens holder element which is formed to be axially coupleable with the lens housing, and a second lens holder element which is formed to be axially coupleable with the image sensor substrate, the first lens holder element and the second lens holder element being formed to be axially coupleable with one another; and
couple the first lens holder element with the lens housing and the second lens holder element, and couple the second lens holder element with the image sensor substrate to install the connecting device.

28. A non-transitory machine-readable memory medium on which is stored a computer program for installing a connecting device for connecting a lens housing which accommodates at least one lens with an image sensor substrate which accommodates an image sensor for a camera, the computer program, when executed by a computer, causing the computer to perform or activate the following steps:
providing a first lens holder element which is formed to be axially coupleable with the lens housing, and a second lens holder element which is formed to be axially coupleable with the image sensor substrate, the first lens holder element and the second lens holder element being formed to be axially coupleable with one another; and
coupling the first lens holder element with the lens housing and the second lens holder element, and coupling the second lens holder element with the image sensor substrate to install the connecting device.
